(19) United States
(12) Patent Application Publication
(10) Pub. No.: US 2011/0091860 A1
(43) Pub. Date: Apr. 21, 2011

(54) MAGNETIC GLASS DRY ERASE BOARD

(75) Inventors: David Mark Supera, Chicago, IL (US); Kenneth Lee Johnson, Itasca, IL (US)

(73) Assignee: AMERICAN GLASS TOP CO., Bensenville, IL (US)

(21) Appl. No.: 12/981,164

(22) Filed: Dec. 29, 2010

Related U.S. Application Data
(63) Continuation-in-part of application No. 12/401,434, filed on Mar. 10, 2009.
(60) Provisional application No. 61/057,109, filed on May 29, 2008.

(51) Int. Cl. B43L 1/00; B32B 37/02; B32B 38/14; B32B 37/12

(52) U.S. Cl. 434/409; 156/60; 156/277

(57) ABSTRACT

A magnetic glass dry erase board including a glass sheet, a metal sheet and an adhesive layer. The glass sheet has an inner surface and an outer surface. The metal sheet has an inner surface and an outer surface. The adhesive layer substantially covers the inner surface of the glass sheet and the outer surface of the metal sheet to retain the glass sheet in a stationary relationship with respect to the metal sheet. The adhesive layer also enhances a strength of the glass sheet and protects persons from injury if the glass sheet is broken by retaining glass pieces on the metal sheet.

### REFERENCE TO RELATED APPLICATION

This application is a continuation-in-part of U.S. application Ser. No. 12/401,434, filed Mar. 10, 2009, the contents of which are incorporated herein by reference. This application claims priority to U.S. Provisional Applic. No. 61/057,109, filed May 29, 2008, the contents of which are incorporated herein by reference.

### FIELD OF THE INVENTION

The invention relates generally to a surface on which a person can write or draw. More particularly, the invention relates to a magnetic glass dry erase board.

### BACKGROUND OF THE INVENTION

In many applications, it is desirable to provide a surface on which a person can write or draw. Because of the costs associated with consumable writing surfaces, it is desirable for the writing surface to permit the surface to be periodically erased or cleared such that the surface may be reused.

One such surface that permits erasing is a chalkboard. Chalkboards typically have a dark color such as black, which facilitates writing or drawing thereon with chalk. The chalk may be removed from the surface of the chalkboard with a variety of mechanisms such as a felt eraser or a rag.

One drawback of chalkboards is that the chalk often produces dust when writing or drawing on the chalkboard as well as when the chalkboard is being erased. In addition to potentially discoloring a person's clothes, the chalk dust may pose a health risk if inhaled.

In an attempt to overcome the drawbacks of conventional chalkboards, dry erase boards have been created. As opposed to a chalkboard, which is typically black, the dry erase boards generally have a white color. As such, dry erase boards are often referred to as whiteboard.

Many higher-quality dry erase boards are fabricated by applying a porcelain coating on a steel sheet. Because of the steel in the dry erase board, it is possible to removably attach objects to the surface of the dry erase board using magnets.

A dry erase marker is typically used in conjunction with the dry erase board. The dry erase marker contains ink that is visible when placed on the dry erase board but which may be removed from the dry erase board using an eraser or cloth. Unlike chalk, the ink used in the dry erase marker does not generate dust when being applied to the dry erase board or when being wiped off of the dry erase board.

Because of the nature of the materials that are utilized in fabricating conventional dry erase boards, it may not be possible to completely erase the dry board, especially where the writing or drawing has been on the dry erase board for an extended period of time, as a portion of the pigment in the dry erase ink becomes permanently absorbed in the surface of the dry erase board. This concept is referred to as ghosting. This inability to completely erase the dry erase board may reduce the ability to see text or images that are subsequently placed on the dry erase board.

### SUMMARY OF THE INVENTION

An embodiment of the invention is directed to a magnetic glass dry erase board. The magnetic glass dry erase board not only enables writing and drawing to be placed thereon and removed therefrom with no ghosting but also enables objects to be removably attached to the magnetic glass dry erase board using magnets.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is an exploded perspective view of a magnetic glass dry erase board according to an embodiment of the invention.

FIG. 2 is a sectional view of the magnetic glass dry erase board.

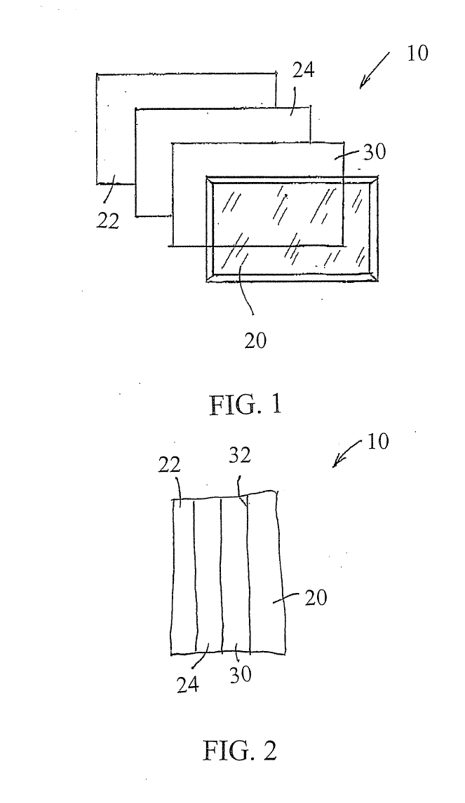

### DETAILED DESCRIPTION OF THE PREFERRED EMBODIMENTS

In its most basic configuration, a magnetic glass dry erase board 10 according to an embodiment of the invention contains a glass sheet 20 and a metal sheet 22, as illustrated in the figures. The magnetic glass dry erase board 10 thereby provides a surface on which text and drawings may be readily placed thereon and removed therefrom as well as enabling objects to be removably attached thereto using magnets.

In certain embodiments, the glass sheet 20 is fabricated from low iron glass. By using low iron glass, the glass does not exhibit a green color, which enhances the aesthetic appearance of the magnetic glass dry erase board 10. As used herein, the term low iron glass means that the glass has an iron concentration of less than about 0.1% by weight iron.

To reduce the potential of injury resulting from breakage of the glass sheet 20, the glass sheet 20 may be fabricated from tempered glass. The glass sheet 20 may be fabricated with a variety of thicknesses. In certain embodiments, the glass sheet 20 has a thickness of between about ⅛ of an inch to about ½ of an inch.

While it is possible for the glass sheet 20 to have a variety of shapes, in one configuration, the glass sheet 20 has a generally rectangular shape. The glass sheet 20 may be fabricated in a variety of dimensions depending upon the location where the magnetic glass dry erase board 10 is to be used. In some embodiments, the glass sheet 20 has a width and a height that are each between about 1 foot and 10 feet.

While it is illustrated that a single glass sheet 20 is utilized to fabricate the magnetic glass dry erase board 10, it is also possible to use multiple glass sheets 20 that are arranged in an array to provide the magnetic glass dry erase board 10 with desired dimensions.

To enhance the appearance of the magnetic glass dry erase board 10, the glass sheet 20 may have beveled edges or a frame (not shown) around at least a portion of the glass sheet 20.

In addition to enabling objects to be removably attached to the magnetic glass dry erase board using magnets, the metal sheet 22 may increase the strength of the magnetic glass dry erase board 10 and thereby reduce the potential of the glass sheet 20 breaking

In one configuration, the metal sheet 22 has a thickness of up to about 26 gauge. Forming the metal sheet 22 with this thickness provides a support for the glass sheet 20 without significantly increasing the weight of the magnetic glass dry erase board 10.

To protect the metal sheet 22 from corrosion and enhance the appearance of the magnetic glass dry erase board 10, the metal sheet 22 may be at least partially covered with a coating. In one configuration, the coating on the metal sheet 22 may be visible through the glass sheet 20 and thereby provide the background color that enhances the visibility of text or drawings placed on the magnetic glass dry erase board 10. The coating may fall within the classification of paint. In such an embodiment, the coating applied to the metal sheet 22 may be a relatively light color.

When writing on dry erase boards, it is typical to use markers having colors that contrast from the color of the dry erase board. Examples of such colors include black, brown, purple, blue, red and green.

While providing the magnetic glass dry erase board 10 with a white color may be desirable in many situations, the color should be relatively light so as to enhance the visibility of markings placed on the magnetic glass dry erase board 10. As used herein, the term relatively light color means a color having little or no hue owing to reflection of almost all incident light. Non-limiting examples of colors that may be used on the magnetic glass dry erase board include white, tan and yellow.

Another way of identifying potential colors for the magnetic glass dry erase board 10 is that there is a significant contrast between the color of the magnetic glass dry erase board 10 and the color(s) of the markings placed thereon.

Another way of defining the color of the magnetic glass dry erase board 10 is that there is a significant difference in the saturation of the color of the magnetic glass dry erase board 10 and the color of the object used to form images on the magnetic glass dry erase board 10. Such difference in color saturation enhances the ability to see the images placed on the magnetic glass dry erase board 10. For example, while red and pink may be in the same color hue, red has a much greater color saturation than pink.

It is expressly indicated that the definition of relatively light color does not include providing a reflective coating such as is typically used on mirrors. While such reflective coating would be beneficial for seeing the reflections of items, it would degrade the ability to see markings placed on the magnetic glass dry erase board 10.

The metal sheet 22 may be attached to the glass sheet 20 using a variety of mechanisms. In some embodiments, an adhesive 24 is used to attach the metal sheet 22 to the glass sheet 20. The adhesive substantially covers the adjoining surfaces of the metal sheet 22 and the glass sheet 20. As used herein, the term substantially covers means that a significant portion of the surface is covered with the adhesive.

This configuration not only enhances the strength of the glass sheet 20 but also enhances the safety associated with the magnetic glass dry erase board 10 because if the glass sheet 20 is broken, the adhesive retains the pieces of glass on the metal sheet 22 to reduce the potential of a person being injured from contact with the glass pieces. A person of skill in the art would appreciate that it is not necessary for the adhesive to entirely cover the surface to attain these benefits.

In addition to or as an alternative to painting the surface of the metal sheet 22, a back surface 30 of the glass sheet 20 may be substantially covered with paint or a ceramic coating 32. Since the paint 32 is on the back side of the glass sheet 20, which is adjacent to the metal sheet 22, this coating does not have to be very durable to withstand contact when using the magnetic glass dry erase board 10. While it is possible for the paint 32 to have a variety of colors, in some configurations, the paint is a relatively light color such as white to enhance the visibility of text or drawings placed on the magnetic glass dry erase board 10.

Placing the coating on the back surface of the glass sheet 20 reduces the potential that the markings placed on the magnetic glass dry erase board 10 will become intermixed with the coating or that the coating would otherwise become damaged as such actions could negatively impact the ability to use the magnetic glass dry erase board 10.

In certain embodiments, the magnetic glass dry erase board 10 may be used by holding in a person's hands or by laying on a support surface such as a table, it is also possible to mount the magnetic glass dry erase board 10 on a wall. A person of skill in the art will appreciate that a variety of techniques may be utilized for mounting the magnetic glass dry erase board 10 on a wall. Examples of which include devices that attach to the metal sheet 22, extend over portions of the metal sheet 22 and/or glass sheet 20, and extend through the metal sheet 22 and/or the glass sheet 20.

As noted above, the metal sheet 22 enables objects to be removably mounted with respect to the magnetic glass dry erase board 10 using magnets. The appropriate type and size of magnet may be selected based upon a variety of factors such as the thickness of the glass sheet 20 and the weight of the object that is to be mounted on the magnetic glass dry erase board 10. In certain embodiments, the magnets must be relatively strong because of the thickness of the glass sheet 20. Examples of relatively strong magnets they may be used in conjunction with the magnetic glass dry erase board 10 are rare earth magnets.

In the preceding Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The preceding Detailed Description, therefore, is not to be taken in a limiting sense, and the scope of the present invention is defined by the appended claims.

It is contemplated that features disclosed in this application, as well as those described in the above applications incorporated by reference, can be mixed and matched to suit particular circumstances. Various other modifications and changes will be apparent to those of ordinary skill.

1. A magnetic glass dry erase board comprising:
a glass sheet having an inner surface and an outer surface;
a metal sheet having an inner surface and an outer surface;
a coating layer applied to a surface of at least one of inner surface of the glass sheet and an outer surface of the metal sheet, wherein the coating layer is a relatively light color; and
an adhesive layer that substantially covers the inner surface of the glass sheet and the outer surface of the metal sheet to retain the glass sheet in a stationary relationship with respect to the metal sheet, enhance a strength of the glass sheet and protect persons from injury if the glass sheet is broken by retaining glass pieces on the metal sheet.

2. The magnetic glass dry erase board of claim 1, wherein the coating layer provides an enhanced contrast for writing that is done on the outer surface of the glass sheet.

3. The magnetic glass dry erase board of claim 1, wherein the coating layer is fabricated from a non-reflective material.

4. The magnetic glass dry erase board of claim 1, wherein the glass sheet is fabricated from glass having an iron concentration of less than about 0.1% by weight.

5. The magnetic glass dry erase board of claim 1, wherein the glass sheet is fabricated from tempered glass.

6. The magnetic glass dry erase board of claim 1, wherein the glass sheet has a length and a width that are approximately the same as a length and a width of the metal sheet.

7. The magnetic glass dry erase board of claim 1, and further comprising a protective coating applied to at least an inner surface of the metal sheet.

8. The magnetic glass dry erase board of claim 1, wherein the metal sheet has a thickness of at least about 26 gauge.

9. A method of forming a magnetic glass dry erase board comprising:
providing a glass sheet having an inner surface and an outer surface;
providing a metal sheet having an inner surface and an outer surface;
applying a coating layer to a surface of at least one of the inner surface of the glass sheet and an outer surface of the metal sheet, wherein the coating layer is a relatively light color; and
applying an adhesive layer that substantially covers the inner surface of the glass sheet and the outer surface of the metal sheet to retain the glass sheet in a stationary relationship with respect to the metal sheet, enhance a strength of the glass sheet and protect persons from injury if the glass sheet is broken by retaining glass pieces on the metal sheet.

10. The method of claim 9, and further comprising applying a coating layer to the inner surface of the glass sheet, wherein the coating layer is between the glass sheet and the adhesive layer.

11. The method of claim 10, wherein the coating layer provides an enhanced contrast for writing that is done on the outer surface of the glass sheet.

12. The method of claim 9, wherein the coating layer is fabricated from a non-reflective material.

13. The method of claim 9, and further comprising fabricating the glass sheet from glass having an iron concentration of less than about 0.1% by weight.

14. The method of claim 9, and further comprising fabricating the glass sheet from tempered glass.

15. The method of claim 9, and further comprising forming the glass sheet with a length and a width that are approximately the same as a length and a width of the metal sheet.

16. The method of claim 9, and further comprising applying a protective coating to at least an inner surface of the metal sheet.

17. The method of claim 9, and further comprising forming the metal sheet with a thickness of at least about 26 gauge.

18. The method of claim 9, and further comprising:
writing on the outer surface of the glass sheet with a dry erase marker; and
positioning an object on the outer surface of the glass sheet utilizing magnetic attraction between the object and the metal sheet.

19. A method of protecting a person from injury while using a magnetic glass dry erase board, wherein the method comprises:
providing a magnetic glass dry erase board comprising a glass sheet having an inner surface and an outer surface, a metal sheet having an inner surface and an outer surface, a coating layer applied to a surface of at least one of the inner surface of the glass sheet and an outer surface of the metal sheet and an adhesive layer that substantially covers the inner surface of the glass sheet and the outer surface of the metal sheet to retain the glass sheet in a stationary relationship with respect to the metal sheet, wherein the coating layer is non-reflective;
subjecting the magnetic glass dry erase board to a force that causes at least a portion of the glass sheet to break into a plurality of glass pieces; and
retaining glass pieces on the metal sheet to prevent a person from contacting edges of the glass pieces.
